(19) United States
(12) Patent Application Publication
(10) Pub. No.: US 2025/0128412 A1
(43) Pub. Date: Apr. 24, 2025

(54) LEARNING COORDINATION POLICIES OVER HETEROGENEOUS GRAPHS FOR HUMAN-ROBOT TEAMS VIA RECURRENT NEURAL SCHEDULE PROPAGATION

(71) Applicant: Georgia Tech Research Corporation, Atlanta, GA (US)

(72) Inventors: Batuhan Altundas, Atlanta, GA (US); Matthew C. Gombolay, Atlanta, GA (US); Zheyuan Wang, Atlanta, GA (US)

(21) Appl. No.: 18/924,908

(22) Filed: Oct. 23, 2024

Related U.S. Application Data
(60) Provisional application No. 63/592,374, filed on Oct. 23, 2023.

(51) Int. Cl. B25J 9/16

(52) U.S. Cl. CPC B25J 9/1661

(57) ABSTRACT

An exemplary deep learning-based system and method are disclosed for human-robot coordination under temporal constraints that has a Heterogeneous Graph-based encoder and a Recurrent Schedule Propagator. The encoder extracts relevant information about the initial environment, while the Propagator generates the consequential models of each task-agent assignments based on the initial model. Inspired by the sensory encoding and recurrent processing of the brain, the approach allows for fast schedule generation, removing the need to interact with the environment between every task-agent pair selection.

### RELATED APPLICATION

This U.S. application claims priority to, and the benefit of, U.S. Provisional Patent Application No. 63/592,374, filed Oct. 23, 2023, entitled “Learning Coordination Policies over Heterogeneous Graphs for Human-Robot Teams via Recurrent Neural Schedule Propagation,” which is incorporated by reference here in its entirety.

### STATEMENT REGARDING FEDERALLY SPONSORED RESEARCH OR DEVELOPMENT

This invention was made with government support under grant nos. N00014-19-1-2076 and GR00010045 awarded by the Office of Naval Research and grant no. N00173-21-1-G009 awarded by the Naval Research Laboratory. The government has certain rights in the invention.

### BACKGROUND

Task Allocation and Scheduling is an Optimization Problem that has impacts on team coordination, job scheduling in manufacturing, or any other area where there is a supply, such as humans or robots, that needs to be assigned to a demand.

While search-based algorithms can provide exact results, they can be time and computationally resource-intensive, and the heuristics require subject-matter experts to account for the problem.

Learning-based models often utilize Graph Neural Networks; however, these models require sequential interaction with the environment and have to be reconstructed after each decision.

There is a benefit to improving task allocation and scheduling.

### SUMMARY

An exemplary deep learning-based system and method are disclosed for human-robot coordination under temporal constraints that have a Heterogeneous Graph-based encoder and a Recurrent Schedule Propagator. The encoder extracts relevant information about the initial environment, while the Propagator generates the consequential models of each task-agent assignment based on the initial model. Inspired by the sensory encoding and recurrent processing of the brain, the approach allows for fast schedule generation, removing the need to interact with the environment between every task-agent pair selection.

The virtual task scheduling environment provided by the exemplary system facilitates mixed human-robot teams in a multi-round setting, capable of modeling the stochastic learning behavior of human workers. The environment may be configured to be OpenAI gym-compatible.

The exemplary system and method may employ a policy model that jointly learns how to pick agents and tasks without interacting with the environment between intermediate scheduling decisions and only needs a single reward at the end of the schedule. By factoring in the action space into an agent selector and a task selector, the exemplary system and method can provide for conditional policy learning that can (i) account for the state and agent models when selecting the agents and (ii) combine the information regarding the tasks, selected agent and the state for task assignment. The exemplary system and method may thus provide an end-to-end trainable via Policy Gradients algorithms.

A study was conducted to validate an implementation of the exemplary system and method (HybridNet) across a set of problem sizes. Results showed HybridNet consistently outperformed prior human-robot scheduling solutions under both deterministic and stochastic settings.

In some embodiments, the exemplary Heterogenous Graph Attention Network system and method employ Message Passing as an Encoder in an Encoder-Decoder Framework for Task Allocation and Scheduling. The exemplary model removes the need for interacting with the environment or simulator. In some embodiments, the Graph Neural Network is trained to (i) encode information associated with heterogenous team structures and tasks and (ii) determine schedules while accounting for spatiotemporal constraints via a recurrent decoder model that employs an output of the Graph Attention Network and sequentially determining task assignments for each agent.

The recurrent decoder can be executed using the construction of the Graph Neural Network of the starting state, using the Recurrent Propagation Module for the next steps and therefore reducing the computation time that is incurred compared to models that require interaction with the environment to update their state representation. The exemplary system and method facilitate a solution to Task Allocation and Scheduling problems under constraints by supplying Agents (Human or Robot) with Tasks to complete in a Heterogeneous Time duration. The exemplary system and method can be employed for any supply and demand setting, with agents representing the supply and tasks representing the delay, e.g., manufacturing, warehouse operations, information technology, etc.

The exemplary system and method can be employed for scheduling only robot systems, as well as human-robot systems. As used herein, a robot can refer to a mechanical or virtual agent carrying out physical activities that can be guided via instructions by a control device.

In an aspect, a system is disclosed comprising: a processor; and a memory having instructions stored thereon, wherein execution of the instruction by the processor causes the processor to: execute a graph network (e.g., Heterogenous Graph Attention Network), the graph network configured to encode information associated with resources (e.g., robot and/or people) and tasks; and execute a recurrent decoder configured to receive an output of the graph network to determine a schedule while accounting for one or more spatiotemporal constraints established by the graph network, wherein the schedule is employed to control or monitor one or more robotic systems.

In some embodiments, the system further includes one or more robotic systems to be controlled or monitored by the system.

In some embodiments, the schedule is employed to control or monitor one or more persons that operate with the one or more robotic systems.

In some embodiments, the graph network has a stochastic policy model that jointly learns to pick agents and tasks without interacting with the environment between intermediate scheduling decisions and only needs a single reward at the end of the schedule.

In some embodiments, the policy model employs conditional policy learning that (i) accounts for the state and agent models when selecting the agents and (ii) combines the information regarding the tasks, selected agent, and the state for task assignment.

In some embodiments, the system is employed for scheduling only robot systems.

In some embodiments, the system is employed for scheduling humna-robot systems.

In some embodiments, the recurrent decoder comprises a Long Short Term Memory cell.

In some embodiments, the recurrent decoder comprises an agent selector and a task selector, wherein the agent selector is configured to select a new agent for the next decision based on state and agent information, wherein the task selector is configured to assign tasks for a selected agent based on the state, agent, and unscheduled task embeddings.

In some embodiments, the stochastic policy model has a step-based baseline.

In some embodiments, the stochastic policy model has a greedy rollout baseline.

In another aspect, a method is disclosed comprising: executing, by a processor, a graph network configured to encode information associated with resources and tasks; and executing, by the processor, a recurrent decoder configured to receive an output of the graph network to determine a schedule while accounting for one or more spatio-temporal constraints established by the graph network, wherein the recurrent decoder is configured to generate consequential models of each task-agent assignments based on an initial model, and wherein the schedule is employed to control or monitor one or more robotic systems.

In some embodiments, the method further includes controlling one or more robotic systems using the schedule.

In some embodiments, the method further includes monitoring one or more robotic systems using the schedule.

In some embodiments, the graph network has a stochastic policy model that jointly learns to pick agents and tasks without interacting with the environment between intermediate scheduling decisions and only needs a single reward at the end of the schedule.

In some embodiments, the recurrent decoder comprises an agent selector and a task selector, wherein the agent selector is configured to select a new agent for a next decision based on state and agent information, wherein the task selector is configured to assign tasks for a selected agent based on the state, agent, and unscheduled task embeddings.

In some embodiments, the stochastic policy model has a step-based baseline.

In some embodiments, the stochastic policy model has a greedy rollout baseline.

In another aspect, a non-transitory computer-readable medium is disclosed having instructions stored thereon, wherein execution of the instruction by a processor causes the processor to: execute a graph network configured to encode information associated with resources and tasks; and execute a recurrent decoder configured to receive an output of the graph network to determine a schedule while accounting for one or more spatio-temporal constraints established by the graph network, wherein the recurrent decoder is configured to generate consequential models of each task-agent assignments based on an initial model, and wherein the schedule is employed to control or monitor one or more robotic systems.

### BRIEF DESCRIPTION OF THE DRAWINGS

FIG. 1 shows an example Multi-Round Environment with an exemplary Scheduler in accordance with an illustrative embodiment.

FIG. 2 shows an example Metagraph of the heterogeneous graph built from the STN by adding agent and state summary nodes in accordance with an illustrative embodiment.

FIG. 3 shows an example algorithm for schedule generation for the scheduler of FIG. 1 in accordance with an illustrative embodiment.

### DETAILED DESCRIPTION

Referring generally to the figures, a needle insertion and tracking device, and method of use, are shown and described according to various implementations.

With collaborative robots (cobots) becoming more available in industrial and manufacturing environments, robots and humans increasingly share the same workspace to collaborate on tasks [1]. By removing the cage around traditional robot platforms and integrating robots into dynamic, final assembly operations, manufacturers can see improvements in reducing a factory's footprint and environmental costs as well as increased productivity [2].

The exemplary system and method provide for multi-agent task allocation and scheduling [3] with mixed human-robot teams over multiple iterations of the same task allocation problem while accounting for and leveraging stochastic, time-varying human task performance to quickly solve task allocation problems among team members to achieve a high-quality schedule with respect to the application-specific objective function while satisfying the temporal constraints (i.e., upper and lower bound deadline, wait, and task duration constraints). Compared to task scheduling within multi-robot systems, the inclusion of human workers makes scheduling even more challenging because, while robots can be programmed to carry out certain tasks at a fixed rate, human workers typically have latent, dynamic, and task-specific proficiencies.

Effective collaboration in human-robot teams requires utilizing the distinct abilities of each team member to achieve safe, effective, and fluent execution. For these problems, the system considers the ability of humans to learn and improve task performance over time. To exploit this property, a scheduling algorithm employs reason about a human's latent performance characteristics to decide whether to assign the best worker to a task now versus giving more task experience to a person who is slower but has a greater potential for fluency at that particular task. However, it is non-trivial to infer human strengths and weaknesses while ensuring that the team satisfies requisite scheduling constraints due to the uncertainty introduced by variability in task execution behavior across different individuals, as well as uncertainty on future task performance affected by human learning effects with practice [4]. Moreover, a lack of consideration for human preferences and perceived equality may, in the long run, put efficient behavior and fluent coordination in a contradiction [5].

Recent advances in scheduling methods for human-robot teams have shown a significant improvement in the ability to dynamically coordinate large-scale teams in final assembly manufacturing [6], [7]. Prior approaches typically rely on an assumption of deterministic or static worker-task proficiencies to formulate the scheduling problem as a mixed-integer linear program (MILP), which is generally NP-hard [8]. Exact methods are hard to scale and often fail to consider the time-varying stochastic task proficiencies of human workers over multi-round schedule execution that could result in significant productivity gains. The heuristic approaches may be able to determine task assignments; however, such approaches require domain-specific knowledge that takes years to gain. The exemplary system and method provide a scalable algorithmic approach that can automatically learn to factor in human behavior for fast and fluent human-robot teaming.

Advancements in artificial intelligence have fostered the idea of leveraging deep neural networks (DNNs) to solve a plethora of problems in operations research [9]. DNNs can be trained to automatically explore the problem structure and discover useful representations in high-dimensional data for constructing high-quality solutions without hand-crafted feature engineering [10]. Particularly, progress has been made in learning scalable solvers with graph neural networks via imitation learning (IL) or reinforcement learning (RL), outperforming state-of-the-art, approximate methods [11], [12], [13].

To address the limitations of prior work, the exemplary system and method, among other things, and in certain embodiments, employ a deep learning-based framework (i.e., HybridNet) for scheduling stochastic human-robot teams under temporal constraints.

### Example System

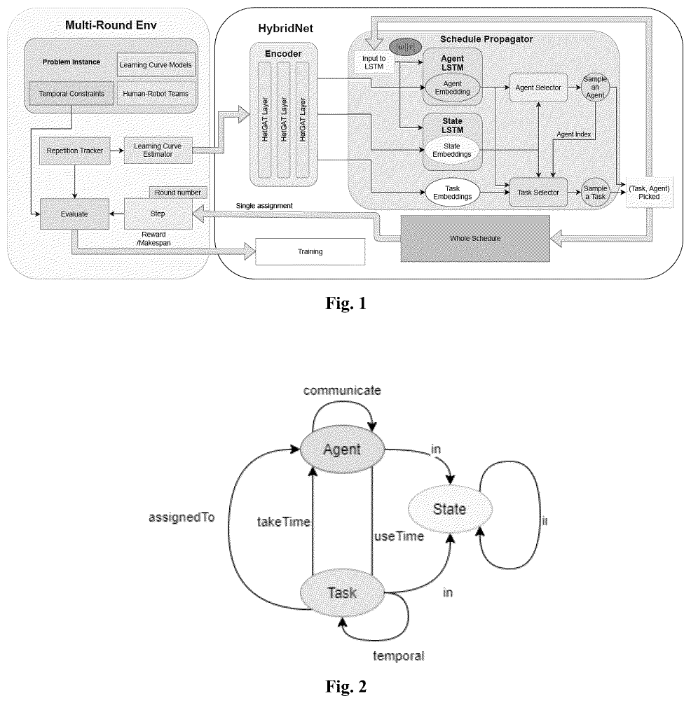

FIG. 1 shows a multi-round environment and exemplary system having a heterogeneous graph-based encoder and a recurrent schedule propagator. The encoder extracts high-level embeddings of the scheduling problem using a heterogeneous graph representation of the problem extended from the simple temporal network (STN) [14]. By formulating task scheduling as a sequential decision-making process, the recurrent propagator uses Long Short Term Memory (LSTM) cells to carry out fast schedule generation. The resulting policy network can provide a computationally lightweight yet highly expressive model that is end-to-end trainable via reinforcement learning algorithms.

Specifically, FIG. 1 shows an example system comprising a multi-round environment with a HybridNet Scheduler. The Multi-Round Scheduling Environment, in the example shown in FIG. 1, can simulate a human-robot scheduling problem over multiple iterative rounds of execution, accounting for changes in human task performance. The HybridNet (FIG. 1) includes a heterogeneous graph-based encoder configured to extract high-level embeddings of the problem and a recurrent schedule propagator for fast schedule generation.

In FIG. 1, the HybridNet framework includes a heterogeneous graph-based encoder to learn high-level embeddings of the scheduling problem and a recurrent schedule propagator to generate the team schedule sequentially. The hybrid network architecture enables direct learning of useful features from the problem structure, owing to the expressiveness of heterogeneous graph neural networks, and at the same time, efficiently constructing the schedule with an LSTM-based propagator. As a result, HybridNet does not require interacting with the environment between every task-agent pair selection, which is necessary but computationally expensive in prior work [16], [23].

π_{θ} (A|S) refers to the policy learned by the system (e.g., HybridNet) with θ representing the parameters of the neural network. At round t, an action takes the form of an ordered sequence of scheduling decisions, Aₜ={d₁, d₂ . . . , dₙ}; dᵢ=(τᵢ, aⱼ), where a latter decision dᵢ is conditioned on its former ones, d_{1:i-1}. Then, the policy can be factorized per Equation 1.

$${p}_{θ} ( {A}_{t} \vert {S}_{t} ) = {\prod }_{i = 1}^{n} {p}_{θ} ( {d}_{i} \vert {S}_{t} , {d}_{1 : i - 1} ) \qquad ( Eq . 1 )$$

In Equation 1, dᵢ=<τᵢ, aⱼ> and p_{θ}(dᵢ|Sₜ, d_{1:i-1}) is the task-agent assignment policy at schedule step i. Using the Recurrent Schedule Propagator, HybridNet recursively computes the conditional probability, p_{θ}(dᵢ|Sₜ, d_{1:i-1}), for sampling a task-agent pair. At the end, the network collects all the decisions and sends them to the environment for execution.

Heterogeneous Graph Encoder. The Encoder using the heterogeneous graph attention (HetGAT) layer proposed in [23] has been shown effective in the representation learning of multi-agent scheduling problems. At the start of each round for a given human-robot scheduling problem, the heterogeneous graph representation is built by extending from the simple temporal network (STN) that encodes the temporal constraints to include agent nodes and a state summary node.

FIG. 2 shows a metagraph of the resulting graph. FIG. 2 summarizes all the node types and edge types. Then, a HetGAT layer computes the output node features by performing per-edge-type message passing followed by per-node-type feature reduction while utilizing a feature-dependent and structure free attention mechanism.

An additional description of the heterogeneous graph attention network is provided in [23], which is incorporated by reference herein in its entirety.

By stacking several HetGAT layers sequentially, the Encoder can be constructed that is configured to utilize a multi-layer structure to extract high-level embeddings of each node that will be sent to the propagator for schedule generation. The same, or similar, hyper-parameters for HetGAT layers, as provided in Wang et al. [23] can be employed.

### Recurrent Schedule Propagator

The HetGAT layers are computationally complex and require interactive scheduling to generate the initial model. By utilizing an LSTM-based Recurrent Predictor, forward consequences of each task-agent assignment can be propagated to recreate the encoded information about the environment without relying on the initial HetGAT Layer, significantly reducing the computational complexity of the scheduler.

The Recurrent Schedule Propagator takes as input the Task, State and Agent embeddings generated by the Heterogeneous Graph Encoder and sequentially generates task agent pairs based on the encoded information. To predict the consecutive encoding of state and agents, an LSTM Model may be used to recursively generate the Agent and State after each assignment of a task to an agent, without interacting with the Environment, outputting the sequential task-agent assignment for the complete set of tasks.

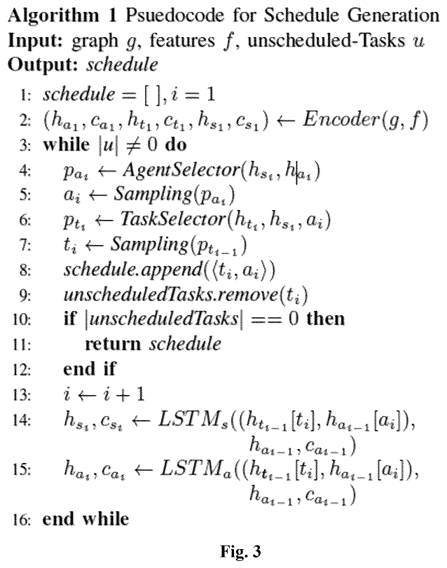

FIG. 3 shows a pseudo-code for scheduling generation with HybridNet as Algorithm 1. In Algorithm 1, as dᵢ=<τᵢ, aⱼ>, p_{θ}(dᵢ|Sₜ, d_{1:i-1}) may be factored into an agent selector and a task selector. That is, π_{factor} (d|⋅)=τ_{agent} (d|⋅)⋅=πₜₐₛₖ(τᵢ|aⱼ;). This factorization allows the policy to capture the underlying composite and conditional nature of the scheduling decisions, where the task to schedule is strongly dependent on the picked agent.

The Agent Selector can select the new agent for the next decision d based on the state and agent information. Specifically, the concatenated state-agent embeddings are processed by a feed-forward neural network fa to compute the likelihood of selecting each agent for the next task-agent pair using Equation 2. A softmax operation can then be performed to convert the raw predictions into a probability distribution. After the selection of the agent, the agent embedding of the chosen agent is updated based on the selected task and state embeddings, as state change only happens for the assigned agent. This approach allows the agent selector to consider how busy each agent is based on the inherent information presented in the embeddings.

$${π}_{agent} ( {a}_{j} \vert s ) = {softmax}_{i} ( {f}_{a} ( [ {h}_{{a}_{j}} ‖ {h}_{s} ] ) ) \qquad ( Eq . 2 )$$

Next, the Schedule Propagator uses the Task Selector to assign the task for the selected agent based on the state, agent and unscheduled task embeddings. As shown in Equation 3, the Task Selector concatenates the state, selected agent, and unscheduled task embeddings and passes the combined information to a feedforward neural network f_{τ} to calculate the likelihood of the task being assigned to the selected agent. After assigning to an agent for execution, the tasks are removed from the list of unscheduled tasks. Since the calculation of the likelihood of each task is independent of each other up to the last softmax operation, the model is scalable and can be used for different problem sizes.

$${π}_{task} ( {τ}_{i} \vert {a}_{j} , s ) = {softmax}_{i} ( {f}_{τ} ( [ {h}_{{τ}_{i}} ‖ {h}_{{a}_{j}} ‖ {h}_{s} ] ) ) \qquad ( Eq . 3 )$$

The component of the Schedule Propagator can use LSTM. As shown in line 12 of Algorithm 1, after each task-agent pair selection, the state and agent embeddings are updated using the state LSTM and agent LSTM, respectively. The LSTM Cell can store the hidden and cell data from the previous step of the task allocation and predict the next step based on the input using Equation Set 4 [33].

$${f}_{t} = σ ( {W}_{f} [ {h}_{t - 1} , {x}_{t} ] + {b}_{f} ) \\ {i}_{t} = σ ( {W}_{i} [ {h}_{t} , {x}_{t} ] + {b}_{i} ) \\ {\tilde{c}}_{t} = tanh ( {W}_{c} [ {h}_{t - 1} , {x}_{t} ] + {b}_{c} ) \\ {c}_{t} = {f}_{t} {c}_{t - 1} + {i}_{t} {\tilde{c}}_{t} \\ {o}_{t} = σ ( {W}_{o} [ {h}_{t - 1} , {x}_{t} ] + {b}_{o} ) \\ {h}_{t} = {o}_{t} tanh ( {c}_{t} ) \qquad ( Eq . Set 4 )$$

In Equation Set 4, the Encoder produces the initial hidden state, h₁ and the initial cell state c₁ as an output in the form of [h₁; c₁]. During testing, a batched sampling strategy may be used for further performance gains. Specifically, multiple schedules may be generated for the same task allocation problem every round. The best performing schedule may be selected by computing the estimated makespan utilizing the Learning Curve Estimator and provide it to the Multi-Round Environment. More sampling improves solution quality at increased computation.

### Stochastic Policy Learning

The exemplary system (HybridNet) may be trained in multi-round scheduling environments using Policy Gradient methods that seek to directly optimize the model parameters based on rewards received from the environment [34]. Specifically, the gradient of the model may be computed using the sum of the log-likelihood of Agent and Task Selectors, as shown in Equation 5:

$${∇}_{θ} J ( θ ) = {E}_{π} ( {\sum }_{t}^{T} {A}_{t}^{{π}_{θ}} ( {s}_{t} , 〈 {τ}_{i} , {a}_{i} 〉 ) {∇}_{θ} ( log {π}_{θ} ( {τ}_{i} \vert {a}_{i} , {s}_{t} ) + log {π}_{θ} ( {a}_{i} \vert {s}_{t} ) ) ) \qquad ( Eq . 5 )$$

In Equation 5, the advantage term Aₜ is estimated by subtracting a “baseline” from the total future reward calculated in Equation 1. The “baseline” may be calculated using the reward generated for the same task-allocation problem from multiple batches executed in multiple sequential rounds in the Multi-Round Environment. Each element of the batch solves the same scheduling problem, and the environment is updated to account for the task-allocation of the previous round, updating the agent models. The gradients were calculated from Equation 5 to update the model weights.

Due to the combinatorial nature of the task scheduling problem, plus the stochasticity in human proficiency, learning a helpful value function as a baseline for computing the advantage term is non-trivial. Step-based baseline and greedy rollout baseline may be used that would be efficient.

Step-based Baseline: As a first value function, during gradient estimation, the baseline value subtracted is set as the average return value across training episodes in the current batch.

Step based: Aᵢ^{π}^{_{θ}}=Rᵢ^{π}^{_{θ}}−R_{μ}^{π}^{_{θ}}

Greedy Rollout Baseline: As a second value function, Greedy Rollout Baseline uses, π_{greedy} (A|S), a deterministic greedy version of the HybridNet scheduler, to collect rewards in the environment. Its weights, θ_{greedy}, are updated periodically by copying the weights from the current learner, π_{θ}(A|S).

Greedy Rollout Baseline: Aᵢ^{π}^{_{θ}}=Rᵢ^{π}^{_{θ}}−R_{greedy}^{π}^{_{θ}}

### Description of Development-Human-Robot Scheduling Problem Formulation

Overview. The problem of human-robot task allocation and scheduling with temporal constraints is devised below. The problem components may be described using a 4-tuple form <α, τ, d, ω>. The parameter a represents all agents that belong to the human-robot team, τ represents all the tasks to be performed. Each task τⱼ and agent aⱼ has a task completion duration dur(τᵢ, aⱼ) and agents are capable of completing a sequence of tasks in order. The parameter d contains the set of deadline constraints, where dᵢ∈d specifies the tasks depending on τᵢ [23]. The parameter ω is the set of wait constraints where ωᵢⱼ∈ω denotes the wait time between tasks τᵢ and τⱼ. A Schedule Sis a sequence of task-agent pairs <τᵢ, aⱼ> such that S contains all tasks in T.

Multi-Round Scheduling Environment. The Multi-Round Scheduling Environment wa developed to simulate a human-robot scheduling problem over multiple iterative rounds of execution, accounting for changes in the task performance of human workers based on previous round. Each round is a step in the OpenAI Gym-compatible environment, taking as input the complete set of task-agent pairs for the scheduling problem, simulating the sequential assignment of tasks to agents.

Each round's execution may be considered finished when all the tasks are assigned to one of the agents or if the provided schedule is determined to be infeasible under the problem constraints. The environment may check the feasibility of the provided schedule given the constraints of the problem and compute the total duration of task completion of the schedule if the schedule is feasible. If the schedule does not satisfy the constraints, it may be determined to be infeasible and the list of tasks that could not be scheduled are returned.

Multi-Round Scheduling Environment. The Multi-Round Scheduling Environment may be developed to simulate a human-robot scheduling problem over multiple iterative rounds of execution, accounting for changes in the task performance of human workers based on the previous round. Each round may be a step in the OpenAI Gym-compatible environment, taking as input the complete set of task-agent pairs for the scheduling problem and simulating the sequential assignment of tasks to agents.

Each round's execution may be considered finished when all the tasks are assigned to one of the agents or if the provided schedule is determined to be infeasible under the problem constraints. The environment checks the feasibility of the provided schedule given the constraints of the problem and computes the total duration of task completion of the schedule if the schedule is feasible. If the schedule does not satisfy the constraints, it is determined to be infeasible and the list of tasks that could not been scheduled are returned. The Multi-Round Scheduling Environment may be formulated as a Partially Observable Markov Decision Process (POMDP) using a six-tuple (S, A, T, R, Ω, O, γ) per Table 1.

TABLE 1

| | |
|---|---|
| States | The problem state S is a state of |
| | the Multi-Round Environment |
| | consistent of the state of the Agents. |
| Actions | Actions at round t within the |
| | Multi-Round Environment refers to a |
| | complete set of Task Allocations |
| | made up of a list of task-agent |
| | pairs, denoted as Aₜ = [<τᵢ₁, αⱼ₁>, |
| | <τᵢ₂, αⱼ₂>, . . . ] to be executed in |
| | order. |
| Transitions: | T corresponds to executing the |
| | action in Multi-Round Scheduling |
| | Environment and proceed to next time step. |
| Rewards: | Rₜ is based on the scheduling |
| | objective a user wants to optimize. Rₜ |
| | may be computed during the |
| | optimizing makespan. |
| Observations: | Ω is the estimated performance of |
| | all the task-agent pairs plus the |
| | observable constraints. |
| Observation Function: | O is handled by the Learning Curve Estimator. |
| Discount factor: | γ |

Agent Models. The Multi-Round Environment may store the Agent information, allowing the environment to keep track of each agent and which tasks it has previously completed. The update of the Environment may occur at the end of each round, allowing agents to modify themselves based on their internal models. to update the model based on the selected (task-agent) pairs for each round.

1) Deterministic Robot Model: The system may generate the robot task completion times randomly through uniform distribution.

2) Stochastic Human Model: The system may generate the human task completion times randomly such that the Environment can be set up to provide Deterministic and Stochastic performance for human learning. The task duration parameters of the human learning model, c, k, β, per the equation y=c+ke^{-βi} are built from the randomly selected initial task completion time for round 0. For Stochastic performance, the standard deviations are used to sample from a Normal Distribution as presented in Liu et al. [4].

Learning Curve Estimator. The scheduler may be given an estimate of the performance of the human agents for each task based on the information about the task duration of the previous executions of the task-agent pair through the Learning Curve Estimator as part of the OpenAI Gym-like Environment. In some embodiments, the system may implement a black box model based on the insights presented in Liu et al. [4] to simulate a Stochastic Human Learning Estimator. As an Agent completes a task in multiple rounds, the Agent Model records the task completion duration, allowing the Learning Curve Estimator to predict the next task-agent duration more accurately. To represent the increase in accuracy from an increase in information, the system may implement a Learning Curve Estimator that generates an estimate of the human agent performance using the actual task performance as the mean of a Gaussian Distribution with noise that exponentially decreases with the number of repetitions of the same task for that agent in previous rounds.

Reward Design. The total reward Rr for the schedule generated by the multi-round scheduling environment may be calculated based on feasible A′ and infeasible Ã′ subsets of task allocations, such that Aₜ=A′ₜ ∪Āₜ′. Specifically, the reward Rr may be based on the expected reward for the feasible subset of task-agent assignments, Rₜ(A′ₜ) and the reward from the assignment of the infeasible subset of task-agent assignments RₜÃₜ′, . . . , based on the point estimate of the reward from assigning the incomplete task to the agent that will complete it in the longest possible duration, multiplied by an infeasible coefficient Ci as shown in Equation 6:

$${R}_{t} = {\sum }_{i ∈ {A}_{t}^{′}} R ( {τ}_{i} , {a}_{i} ) + {C}_{i} {max}_{{a}_{j}} ( {\sum }_{i ∈ {\tilde{A}}^{′}} R ( {τ}_{i} , {a}_{j} ) ) \qquad ( Eq . 6 )$$

The Total Schedule Reward Rs may favor schedules with more feasible task allocations and enables learning from infeasible explorations during training.

### Experimental Results and Additional Examples

A study was conducted to develop and evaluate a deep learning-based framework (HybridNet) that combines a heterogeneous graph-based encoder with a recurrent schedule propagator for scheduling stochastic human-robot teams under temporal constraints. The resulting policy network provides a computationally lightweight yet highly expressive model that is end-to-end trainable via reinforcement learning algorithms. The study developed a multi-round task scheduling environment for stochastic human-robot teams and conducted extensive experiments, showing that HybridNet outperforms other human-robot scheduling solutions across problem sizes. The study can integrate the learning-based human estimator into HybridNet, transfer learning across optimizing different objective functions, and deploy the trained network in a real-world scenario.

The empirical results and analysis from the study demonstrates that HybridNet establishes a state-of-the-art in autonomously learning policies for coordinating stochastic human-robot teams in a computationally efficient framework. In particular, the study demonstrated that:

1) The Heterogeneous Graph Attention Model is able to leverage the relationships between individual units within the problem to generate more informed embeddings. The node feature updates can utilize different types of structural information efficiently to generate representations used by the selector model in FIGS. 4 and 5 (Appendix A) toward fast decision generation for the policy.

2) The model of the study is scalable in both data scale and sample size. This allows the system to train HybridNet via policy optimization on small problems to provide high-quality schedules on much larger problems, as shown in Tables 2 and 3.

3) Compared to pure GNN-based schedulers, the use of the Recurrent Scheduler Propagator brings in much speedup. When leveraging sample space for schedule boosting, the Encoding generated by the Heterogeneous Graph Encoder is shared across multiple scheduler rollouts of the propagator. This allows for sequential task allocation to be done without needing to rebuild the Graph Model after the initial construction in both training and testing.

As only a single Graph Model is generated per training step, Proximal Policy Optimization only needs to store a single instance of the graph model to optimize the clipped surrogate objective.

Data Generation. The study generated scheduling problems with deadline and wait constraints under different scales. For all scales, the deadline constraints were randomly generated for approximately 25% of the tasks from a range of [1, 5N] where N is the number of tasks. Approximately 25% of the tasks had wait constraints, and the duration of non-zero wait constraints was sampled from U ([1; 10]). Task durations were clamped to 10 to 100.

1) Small Scale: The small data set had 9 to 11 tasks with 2 robots and 2 humans in a team. The study generated 2000 Training Problems and 200 Test Problems.

2) Medium Scale: The medium data set had 18 to 22 tasks with 2 robots and 2 humans in a team. The study generated 2000 Training Problems and 200 Test Problems to inspect the scalability of the trained model.

3) Large Scale: The large data set was defined as problems with 36 to 44 tasks chosen at random with 2 robots and 2 humans in a team. The study generated 200 Test Problems to evaluate the HybridNet performance with zero training problems (i.e., zero-shot transfer to from the smaller-scale datasets to the Large Scale dataset).

To simulate the stochastic learning of human agents, for each Data Set, noise was introduced to the Human Agent models by simulating the natural distribution of the c, k, β parameters of the equation y=c+ke^{-βi}. This allowed for each of the Data Set to simulate Deterministic and Stochastic Human Performance. The stochastic model was clipped to fall within the specified range of task durations.

Benchmarking. The study benchmarked HybridNet against EDF algorithms and genetic algorithms.

Earliest deadline first (EDF) is a ubiquitous heuristic algorithm that selects from a list of available tasks the one with the earliest deadline, assigning it to the first available agent.

Genetic Algorithm is an Evolutionary Optimization Algorithm that uses Post-Processing on the Schedule Generated by EDF [21]. The genetic algorithm creates new schedules based on the initial schedule through iterative randomized mutations by swapping task allocations and task orders [4]. Each generation selects the top performing schedules, sorted on feasibility and total schedule completion time, and used as the baseline for creating new mutations. The Genetic Algorithm was run for 10 generations with 90 baseline schedules, 10 task allocation, and 10 task order swapping mutations.

The study also evaluated the functionality of the Recurrent Schedule Propagator by comparing it against a HybridNet variant. The study implemented a HetGAT Scheduler based on the Encoder of HybridNet. After each task-agent pair assignment, instead of using the LSTM Cells to update the task, agent, and state embeddings, the scheduler directly interacted with the environment to model the consequences of action with a new heterogeneous graph and re-computes that information from it.

The study evaluated HybridNet on three metrics: 1) Proportion of problems solved; 2) Adjusted makespan: determined by the average of the makespan of feasible schedules and the maximum possible makespan of the infeasible schedules; and 3) Runtime statistics. Runtime statistics for training and execution are compared for HybridNet and HetGAT Scheduler to model their computational complexity. Because the HetGAT Scheduler relies on interactive scheduling through the environment after every task-agent pair allocation, the study only trained and evaluated it for Deterministic Human Performance.

Model Details. The study implemented HybridNet and HetGAT using PyTorch [35] and Deep Graph Library [36]. The HybridNet Encoder used in training/testing is constructed by stacking three multi-head HetGAT layers (the first two use concatenation and the last

one uses averaging). The feature dimension of hidden layers=64, and the number of heads=8. The Recurrent Propagator utilized an LSTM-Cell of size 32 followed by a fully connected layer and a softmax layer. The study set γ=0.99, batch size=8 and used Adam optimizer with a learning rate of 2×10⁻³, and a weight decay of 5×10⁻⁴. The study employed a learning rate decay of 0:5 every 4000 epochs The study evaluated the models using a batch size of 8 and 16. For the Multi-Round Environment, the infeasible reward coefficient Cᵢ=2.0 and the total round number=4. Both training and evaluation were conducted on a Quadro RTX 8000 GPU.

Evaluation Results. Table 2 (shown as Table 2A, Table 2B, and Table 2C) shows the evaluation performance with Deterministic Human Proficiency in different scales. The Deterministic Human Proficiency means that during training and evaluation, the human learning curve is known, and execution is deterministic for every agent. In Table 2, “Small” and “Medium” terms after the model name denote the data scale the model was trained on, and the number following it denotes the batch size for schedule sampling. The results show that HybridNet outperforms both EDF and Genetic Algorithm in adjusted makespan and percentage of feasibility. HybridNet trained on Small scale problems generalizes for both Medium and Large scale problems with similar or slightly worse performance than HybridNet trained on Medium. HybridNet and HetGAT perform similarly on all scales. This shows that HybridNet is capable of learning high-performance policies by leveraging the Recurrent Schedule Propagator and without requiring interaction with the Environment.

TABLE 2A

| | | Small | |
|---|---|---|---|
| Training | Methods | Makespan | Feasibility (%) |
| — | EDF | 239.31 | 73.00 |
| — | Genetic Algorithm | 302.42 ± 0.77 | 74.10 ± 0.30 |
| Step-based | HetGAT 8 | 257.20 ± 0.18 | 86.29 ± 0.08 |
| | HetGAT 16 | 249.69 ± 0.30 | 86.51 ± 0.09 |
| Greedy | HetGAT 8 | 261.15 ± 0.09 | 85.59 ± 0.10 |
| | HetGAT 16 | 255.70 ± 0.23 | 86.05 ± 0.15 |
| Step-based | HybridNet Small 8 | 260.22 ± 0.15 | 86.93 ± 0.10 |
| | HybridNet Small 16 | 252.57 ± 0.49 | 87.08 ± 0.10 |
| Greedy | HybridNet Small 8 | 266.74 ± 0.31 | 84.65 ± 0.32 |
| | HybridNet Small 16 | 258.17 ± 0.45 | 85.13 ± 0.20 |
| Step-based | HybridNet Medium 8 | — | — |
| | HybridNet Medium 16 | — | — |
| Greedy | HybridNet Medium 8 | — | — |
| | HybridNet Medium 16 | — | — |

TABLE 2B

| | | Medium | |
|---|---|---|---|
| Training | Methods | Makespan | Feasibility (%) |
| — | EDF | 1109.85 | 15.00 |
| — | Genetic Algorithm | 1180.07 ± 2.54 | 16.60 ± 0.70 |
| Step-based | HetGAT 8 | 751.27 ± 1.29 | 50.17 ± 0.14 |
| | HetGAT 16 | 723.57 ± 0.94 | 50.29 ± 0.11 |
| Greedy | HetGAT 8 | 784.32 ± 0.52 | 53.28 ± 0.17 |
| | HetGAT 16 | 765.79 ± 0.96 | 53.41 ± 0.08 |
| Step-based | HybridNet Small 8 | 770.48 ± 1.07 | 59.11 ± 0.35 |
| | HybridNet Small 16 | 746.35 ± 0.52 | 60.89 ± 0.36 |
| Greedy | HybridNet Small 8 | 758.96 ± 2.27 | 61.09 ± 0.43 |
| | HybridNet Small 16 | 723.35 ± 1.70 | 63.68 ± 0.49 |
| Step-based | HybridNet Medium 8 | 722.85 ± 0.61 | 64.69 ± 0.29 |
| | HybridNet Medium 16 | 697.40 ± 2.04 | 66.25 ± 0.51 |
| Greedy | HybridNet Medium 8 | 692.01 ± 3.69 | 68.33 ± 0.66 |
| | HybridNet Medium 16 | 659.01 ± 0.89 | 71.00 ± 0.45 |

TABLE 2C

| | | Large | |
|---|---|---|---|
| Training | Methods | Makespan | Feasibility (%) |
| — | EDF | 2535.89 | 1.00 |
| — | Genetic Algorithm | 2542.79 ± 0.06 | 1.00 ± 0.00 |
| Step-based | HetGAT 8 | 2123.96 ± 5.66 | 17.12 ± 0.27 |
| | HetGAT 16 | 2081.65 ± 5.45 | 17.15 ± 0.16 |
| Greedy | HetGAT 8 | 2017.25 ± 2.16 | 23.98 ± 0.14 |
| | HetGAT 16 | 1983.73 ± 1.59 | 23.84 ± 0.01 |
| Step-based | HybridNet Small 8 | 2005.80 ± 2.33 | 30.65 ± 0.39 |
| | HybridNet Small 16 | 1953.65 ± 3.76 | 33.24 ± 0.61 |
| Greedy | HybridNet Small 8 | 2049.32 ± 3.73 | 28.74 ± 0.45 |
| | HybridNet Small 16 | 1973.15 ± 2.91 | 32.46 ± 0.40 |
| Step-based | HybridNet Medium 8 | 2010.86 ± 1.97 | 30.86 ± 0.45 |
| | HybridNet Medium 16 | 1944.72 ± 4.10 | 33.88 ± 0.49 |
| Greedy | HybridNet Medium 8 | 2011.78 ± 5.08 | 30.58 ± 0.87 |
| | HybridNet Medium 16 | 1936.97 ± 4.68 | 34.66 ± 0.74 |

Table 3 shows the runtimes of training and evaluation for HetGAT and HybridNET. HybridNet was approximately 10 times faster in training compared to the HetGAT Model and at least 2 times faster during evaluation for the same batch size. EDF and Genetic Algorithm were evaluated through the CPU without GPU acceleration, making it infeasible to accurately compare the performance of the Deep Learning Models to the Traditional Models.

TABLE 3

| | Methods | HetGAT8 | HybridNet8 | HybridNet16 |
|---|---|---|---|---|
| Training | Small | 184.52 ± 18.00 | 19.97 ± 0.91 | — |
| Time (s) | Medium | 354.77 ± 38.31 | 22.40 ± 6.52 | — |
| Evaluation | Small | 22.91 ± 5.85 | 10.94 ± 0.99 | 18.95 ± 3.53 |
| Time (s) | Medium | 70.12 ± 8.67 | 14.77 ± 1.42 | 22.30 ± 7.55 |
| | Large | 123.76 ± 32.32 | 18.84 ± 7.38 | 27.78 ± 16.52 |

The results show that for HybridNet, step-based training has better performance over the greedy baseline, while for the HetGAT model, greedy baseline training is better. The results also confirmed that both may be utilized. The study also observed that greedy baseline training reached convergence faster than step-based training (4500 epochs vs. 19000 epochs).

Table 4 (shown as Table 4A and Table 4B) shows the evaluation performance with Stochastic Human Proficiency in different scales. The Stochastic Human Proficiency is presented as randomness in both the actual human execution within the Multi-Round Environment and uncertainty within the Learning Curve Estimator used for schedule generation. The results show that HybridNet outperforms the EDF and Genetic Algorithm across different data scales. The largest performance gap was observed on a large dataset (23.51% vs. 1.15%). Here, the HetGAT model was not included as it required interaction with the environment after every task-agent assignment to observe the outcome, which is not available until the whole schedule is generated and sent to the Stochastic Environment for execution to emulate real-world scenarios.

TABLE 4A

| | Small | | Medium | |
|---|---|---|---|---|
| | | Feasibility | | Feasibility |
| Methods | Makespan | (%) | Makespan | (%) |
| EDF | 227.81± 6.17 | 75.65 ± 1.21 | 1071.02 ± 20.65 | 17.30 ± 1.12 |
| Genetic | 283.79 ± 10.39 | 77.45 ± 2.05 | 1149.42 ± 12.14 | 19.55 ± 1.31 |
| Algorithm | | | | |
| HybridNet | 298.81 ± 0.96 | 79.54 ± 0.52 | 881.16 ± 2.89 | 48.89 ± 1.09 |
| Small | | | | |
| HybridNet | — | — | 859.99 ± 4.82 | 51.94 ± 1.32 |
| Medium | | | | |

TABLE 4B

| | Large | |
|---|---|---|
| Methods | Makespan | Feasibility (%) |
| EDF | 2524.92 ± 8.95 | 1.15 ± 0.23 |
| Genetic Algorithm | 2541.20 ± 3.54 | 1.05 ± 0.15 |
| HybridNet Small | 2141.80 ± 5.12 | 23.51 ± 0.96 |
| HybridNet Medium | 2174.57 ± 8.53 | 22.31 ± 0.94 |

### Discussion

The exemplary system and method can employ learning of a scalable model without the requirement of an expert, thus providing fast solutions without having to interact with an environment, making it ideal for real-world deployment with pre-planning where the simulation of the intermediate states is not feasible or lacking. Typically, exact solvers often require experts to develop and are computationally expensive and slow. Heuristic Solvers, for example, require the developer to have familiarity with the application to account for any constraints, leading to expensive development and deployment costs, while providing sub-optimal solutions. Of the existing learning-based methods, Convolutional Neural Network based models for Task Allocation are not Scalable, while existing previous Graph Neural Networks are either not able to model Heterogeneity of the Supply, or require interaction with the simulation for sequential decision-making, making them slow and require the development of representative environments which may not always be feasible.

The exemplary system and method can leverage the scalability of the Graph-based learning models, removing the need to interact with an environment and removing the need to simulate the intermediate stages. The learned models are better at accounting for constraints than existing heuristics and faster than other learning-based approaches. To deploy the model, in some embodiments, the problem is converted into a framework that is compatible with the existing applications in the form of Single Agent-Single Agent Problems under Temporal Constraints. The model can also be further modified to better represent the constraints and relationships within the problem. A reward model has to be developed to determine the “goodness” of a given policy that is generated. This reward model was used to train the model (the model needs to be trained using the developed reward model).

Multi-Agent Scheduling Problem. Task assignment and scheduling of multi-agent systems is an optimization problem that has been studied for real-world applications, both for Multi-Robot Task Allocation (MRTA) problems using traditional techniques [15] and deep learning-based techniques [16] as well as for human-robot collaboration [7]. Task Allocation can be formalized by Mixed Integer Linear Programming (MILP) to capture it's constraints. The exponential complexity of solving the MILP can be accelerated through constraint programming methods [7], [17], [18] or heuristic schedulers to leverage better scalability [19], [20]. Zhang et al. encoded task schedules as chromosomes for a genetic algorithm that optimized schedules for heterogeneous human-robot collaboration by repeatedly crossing over and mutating the solutions to find the optimal schedule [21].

Gombolay et al. presented an algorithm to capture domain knowledge through a scheduling policy requiring domain-expert demonstrations [22]. Wang et al. proposed ScheduleNet, a Heterogenous Graph Neural Networks-based model for task allocation under temporospatial constraints, trained through Imitation Learning using optimal schedule [23]. ScheduleNet relies on an interactive scheduling scheme, with constant updates of an environment before reaching a complete schedule. These approaches require optimal schedules generated by other expert systems to train and have high computational complexity that makes their implementation costly.

Modeling Human-Robot Teams. As advancements in robot capability progress, they become safer and more effective to use in conjunction with humans to complete specialized work. Liu et al. presents a model of human task completion, showing an increase in task efficiency as a result of learning. The study determined that prediction of human performance enhances the ability of the scheduling systems to explicitly reason about the agents' capabilities [4]. Prior work on behavioral teaming and the natural computational intractability of large-scale schedule optimization suggests that robots can offer a valuable service by designing and adapting schedules for human teammates.

In the study, the findings of Liu et al. were considered to account for human learning over time, both in problem generation as part of the environment and a learning curve predictor as part of the scheduling policy. The human learning curve may follow an exponential function of generic form over the course of multiple iterations per: y=c+ke−^{βi} [4], where i is the number of iterations the human has previously executed a task and c, k, β parameters. The instant study further accounted for the stochastic nature of human learning in the environment.

Graph Neural Networks. Graph Neural Networks (GNNs) are a class of deep neural networks that learn from unstructured data by representing objects as nodes and relations as edges and aggregating information from nearby nodes [24]. GNNs have been widely applied in graph-based problems such as node classification, link prediction and clustering, and they have shown to have an impressive performance [25]. The Heterogeneous Graph Attention Network presented in Wang et al. utilizes Deep Learning Algorithms to address the Scheduling Problem, showing improved performance compared to non-Deep Learning Schedulers such as Earliest-Deadline First (EDF) and Tercio [7] at the cost of increased computational complexity [23].

LSTM Based Sequence Prediction. The impact of the LSTM network has been notable

in language modeling [27], speech-to-text transcription [28], machine translation [29], and other applications that involve predictive modeling [30], [31], [32]. The lengthier path generated through the recurrent nature of the neural network can provide an opportunity to build a certain degree of intuition that can prove beneficial during all phases of the process [30], [33].

### Configuration of Certain Implementations

The construction and arrangement of the systems and methods as shown in the various implementations, are illustrative only. Although only a few implementations have been described in detail in this disclosure, many modifications are possible (e.g., variations in sizes, dimensions, structures, shapes, and proportions of the various elements, values of parameters, mounting arrangements, use of materials, colors, orientations, etc.). For example, the position of elements may be reversed or otherwise varied, and the nature or number of discrete elements or positions may be altered or varied. Accordingly, all such modifications are intended to be included within the scope of the present disclosure. The order or sequence of any process or method steps may be varied or re-sequenced according to alternative implementations. Other substitutions, modifications, changes, and omissions may be made in the design, operating conditions, and arrangement of the implementations without departing from the scope of the present disclosure.

The present disclosure contemplates methods, systems, and program products on any machine-readable media for accomplishing various operations. The implementations of the present disclosure may be implemented using existing computer processors, or by a special purpose computer processor for an appropriate system, incorporated for this or another purpose, or by a hardwired system. Implementations within the scope of the present disclosure include program products, including machine-readable media for carrying or having machine-executable instructions or data structures stored thereon. Such machine-readable media can be any available media that can be accessed by a computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures, and which can be accessed by a general purpose or special purpose computer or other machine with a processor.

When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general-purpose computer, special purpose computer, or special purpose processing machines to perform a certain function or group of functions.

Although the figures show a specific order of method steps, the order of the steps may differ from what is depicted. Also, two or more steps may be performed concurrently or with partial concurrence. Such variation will depend on the software and hardware systems chosen and on designer choice. All such variations are within the scope of the disclosure. Likewise, software implementations could be accomplished with programming techniques with rule-based logic and other logic to accomplish the various connection steps, processing steps, comparison steps and decision steps.

It is to be understood that the methods and systems are not limited to specific synthetic methods, specific components, or to particular compositions. It is also to be understood that the terminology used herein is for the purpose of describing particular implementations only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another implementation includes from the one particular value and/or to the other particular value. Similarly, when values are expressed as approximations, by use of the antecedent “about,” it will be understood that the particular value forms another implementation. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers or steps. “Exemplary” means “an example of” and is not intended to convey an indication of a preferred or ideal implementation. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific implementation or combination of implementations of the disclosed methods.

The following patents, applications and publications as listed below and throughout this document are hereby incorporated by reference in their entirety herein.

### REFERENCES

[1] Z. Yan, N. Jouandeau, and A. A. Cherif, “A survey and analysis of multi-robot coordination,” International Journal of Advanced Robotic Systems, vol. 10, no. 12, p. 399, 2013. [Online]. Available: https://doi.org/10.5772/57313
[2] C. Heyer, “Human-robot interaction and future industrial robotics applications,” in 2010 IEEE/RSJ International Conference on Intelligent Robots and Systems. IEEE, 2010, pp. 4749-4754.
[3] E. Nunes, M. Manner, H. Mitiche, and M. Gini, “A taxonomy for task allocation problems with temporal and ordering constraints,” Robotics and Autonomous Systems, vol. 90, pp. 55-70, 2017.
[4] R. Liu, M. Natarajan, and M. C. Gombolay, “Coordinating humanrobot teams with dynamic and stochastic task proficiencies,” ACM Transactions on Human-Robot Interaction (THRI), vol. 11, no. 1, pp. 1-42, 2021.
[5] M. C. Gombolay, R. A. Gutierrez, S. G. Clarke, G. F. Sturla, and J. A. Shah, “Decision-making authority, team efficiency and human worker satisfaction in mixed human-robot teams,” Autonomous Robots, vol. 39, no. 3, pp. 293-312, 2015.
[6] E. Nunes and M. Gini, “Multi-robot auctions for allocation of tasks with temporal constraints,” in Twenty-Ninth AAAI Conference on Artificial Intelligence, 2015, pp. 2110-2116.
[7] M. C. Gombolay, R. J. Wilcox, and J. A. Shah, “Fast scheduling of robot teams performing tasks with temporospatial constraints,” IEEE Transactions on Robotics, vol. 34, no. 1, pp. 220-239, 2018.
[8] M. M. Solomon, “On the worst-case performance of some heuristics for the vehicle routing and scheduling problem with time window constraints,” Networks, vol. 16, no. 2, pp. 161-174, 1986.
[9] Y. Bengio, A. Lodi, and A. Prouvost, “Machine learning for combinatorial optimization: a methodological tour d'horizon,” European Journal of Operational Research, vol. 290, no. 2, pp. 405-421, 2021.
   [10] Y. LeCun, Y. Bengio, and G. Hinton, “Deep learning,” nature, vol. 521, no. 7553, pp. 436-444, 2015.
[11] E. Khalil, H. Dai, Y. Zhang, B. Dilkina, and L. Song, “Learning combinatorial optimization algorithms over graphs,” in Advances in Neural Information Processing Systems, 2017, pp. 6348-6358.
[12] W. Kool, H. van Hoof, and M. Welling, “Attention, learn to solve routing problems!” in International Conference on Learning Representations, 2019.
[13] T. Ma, P. Ferber, S. Huo, J. Chen, and M. Katz, “Online planner selection with graph neural networks and adaptive scheduling,” Proceedings of the AAAI Conference on Artificial Intelligence, vol. 34, no. 04, pp. 5077-584 April 2020. [Online]. Available: https://ojs.aaai.org/index.php/AAAI/article/view/5949
[14] R. Dechter, I. Meiri, and J. Pearl, “Temporal constraint networks,” Artificial intelligence, vol. 49, no. 1-3, pp. 61-95, 1991.
[15] B. Altundas, Z. Wang, J. Bishop, and M. C. Gombolay, “Learning coordination policies over heterogeneous graphs for human-robot teams via recurrent neural schedule propagation,” in 2022 IEEE/RSJ International Conference on Intelligent Robots and Systems (IROS), 2022, pp. 11 679-11 686.
[16] E. Nunes, M. Manner, H. Mitiche, and M. Gini, “A taxonomy for task allocation problems with temporal and ordering constraints,” Robotics and Autonomous Systems, vol. 90, pp. 55-70, April 2017, publisher Copyright: @ 2016 Elsevier B.V.
[17] Z. Wang and M. Gombolay, “Learning scheduling policies for multirobot coordination with graph attention networks,” IEEE Robotics and Automation Letters, vol. 5, no. 3, pp. 4509-4516, 2020.
[18] J. F. Benders, “Partitioning procedures for solving mixed-variables programming problems,” Numerische Mathematik, vol. 4, no. 1, pp. 238-252, December 1962. [Online]. Available: https://doi.org/10.1007/bf01386316.
[19] E. Castro and S. Petrovic, “Combined mathematical programming and heuristics for a radiotherapy pre-treatment scheduling problem,” Journal of Scheduling, vol. 15, no. 3, pp. 333-346, May 2011. [Online]. Available: https://doi.org/10.1007/s10951-011-0239-8
[20] J. Chen and R. Askin, “Project selection, scheduling and resource allocation with time dependent returns,” European Journal of Operational Research, vol. 193, pp. 23-34, 02 2009.
[21] S. Zhang, Y. Chen, J. Zhang, and Y. Jia, “Real-time adaptive assembly scheduling in human-multi-robot collaboration according to human capability*,” 2020 IEEE International Conference on Robotics and Automation (ICRA), pp. 3860-3866, 2020.
[22] M. C. Gombolay, “Apprenticeship scheduling for human-robot teams,” in Proceedings of the Thirtieth AAAI Conference on Artificial Intelligence, ser. AAAI′16. AAAI Press, 2016, p. 2497-2498.
[23] Z. Wang, C. Liu, and M. Gombolay, “Heterogeneous graph attention networks for scalable multi-robot scheduling with temporospatial constraints,” Autonomous Robots, vol. 46, no. 1, pp. 249-268, 2022.
[24] F. Scarselli, M. Gori, A. C. Tsoi, M. Hagenbuchner, and G. Monfardini, “The graph neural network model,” Trans. Neur. Netw., vol. 20, no. 1, p. 61-80, January 2009. [Online]. Available: https://doi.org/10.1109/TNN.2008.2005605
[25] K. Xu, W. Hu, J. Leskovec, and S. Jegelka, “How powerful are graph neural networks?” in International Conference on Learning Representations, 2019.
[26] J. Singh, “An algorithm to reduce the time complexity of earliest deadline first scheduling algorithm in real-time system,” 2010.
[27] M. Sundermeyer, R. Schl″uter, and H. Ney, “Lstm neural networks for language modeling,” in Thirteenth annual conference of the international speech communication association, 2012.
[28] A. Graves, S. Fernandez, and J. Schmidhuber, “Bidirectional lstm networks for improved phoneme classification and recognition,” in International conference on artificial neural networks. Springer, 2005, pp. 799-804.
[29] J. Zhou, G. Cui, S. Hu, Z. Zhang, C. Yang, Z. Liu, L. Wang, C. Li, and M. Sun, “Graph neural networks: A review of methods and applications,” 2021.
[30] A. Sherstinsky, “Fundamentals of recurrent neural network (RNN) and long short-term memory (LSTM) network,” CoRR, vol. abs/1808.03314, 2018. [Online]. Available: http://arxiv.org/abs/1808.
[31] P. Malhotra, A. Ramakrishnan, G. Anand, L. Vig, P. Agarwal, and G. Shroff, “Lstm-based encoder-decoder for multi-sensor anomaly detection,” arXiv preprint arXiv: 1607.00148, 2016.
[32] A. Ycart, E. Benetos, et al., “A study on lstm networks for polyphonic music sequence modelling.” ISMIR, 2017.
[33] Y. Yu, X. Si, C. Hu, and J. Zhang, “A review of recurrent neural networks: Lstm cells and network architectures,” Neural Computation, vol. 31, no. 7, pp. 1235-1270, 2019.
[34] R. S. Sutton, S. Singh, and D. McAllester, “Comparing policy-gradient algorithms,” IEEE Transactions on Systems, Man, and Cybernetics, 2000.
[35] A. Paszke, S. Gross, F. Massa, A. Lerer, J. Bradbury, G. Chanan, T. Killeen, Z. Lin, N. Gimelshein, L. Antiga, A. Desmaison, A. Kopf, E. Yang, Z. DeVito, M. Raison, A. Tejani, S. Chilamkurthy, B. Steiner, L. Fang, J. Bai, and S. Chintala, “Pytorch: An imperative style, high-performance deep learning library,” in Advances in Neural Information Processing Systems, H. Wallach, H. Larochelle, A. Beygelzimer, F. d'Alch'e-Buc, E. Fox, and R. Garnett, Eds., vol. 32. Curran Associates, Inc., 2019.
[36] M. Wang, D. Zheng, Z. Ye, Q. Gan, M. Li, X. Song, J. Zhou, C. Ma, L. Yu, Y. Gai, T. Xiao, T. He, G. Karypis, J. Li, and Z. Zhang, “Deep graph library: A graph-centric, highly-performant package for graph neural networks,” 2020.
[37] D. P. Kingma and J. Ba, “Adam: A method for stochastic optimization,” 2017.

What is claimed is:

1. A system comprising:
a processor; and
a memory having instructions stored thereon, wherein execution of the instruction by the processor causes the processor to:
execute a graph network configured to encode information associated with resources and tasks; and
execute a recurrent decoder configured to receive an output of the graph network to determine a schedule while accounting for one or more spatio-temporal constraints established by the graph network, wherein the recurrent decoder is configured to generate consequential models of each task-agent assignments based on an initial model, and
wherein the schedule is employed to control or monitor one or more robotic systems.

2. The system of claim 1 further comprising:
one or more robotic systems to be controlled or monitored by the system.

3. The system of claim 1 wherein the schedule is employed to control or monitor one or more persons that operate with the one or more robotic systems.

4. The system of claim 1, wherein the graph network has a stochastic policy model that jointly learns to pick agents and tasks without interacting with an environment between intermediate scheduling decisions and only needs a single reward at an end of the schedule.

5. The system of claim 4, wherein the policy model employs conditional policy learning that (i) accounts for state and agent models when selecting the agents and (ii) combines the information regarding the tasks, selected agent, and the state for task assignment.

6. The system of claim 1, wherein the system is employed for scheduling only robot systems.

7. The system of claim 1, wherein the system is employed for scheduling human-robot systems.

8. The system of claim 1, wherein the recurrent decoder comprises a Long Short Term Memory cell.

9. The system of claim 1, wherein the recurrent decoder comprises an agent selector and a task selector, wherein the agent selector is configured to select a new agent for a next decision based on state and agent information, and wherein the task selector is configured to assign tasks for a selected agent based on the state, agent, and unscheduled task embeddings.

10. The system of claim 4, wherein the stochastic policy model has a step-based baseline.

11. The system of claim 4, wherein the stochastic policy model has a greedy rollout baseline.

12. A method comprising:
executing, by a processor, a graph network configured to encode information associated with resources and tasks; and
executing, by the processor, a recurrent decoder configured to receive an output of the graph network to determine a schedule while accounting for one or more spatiotemporal constraints established by the graph network, wherein the recurrent decoder is configured to generate consequential models of each task-agent assignments based on an initial model, and
wherein the schedule is employed to control or monitor one or more robotic systems.

13. The method of claim 12 further comprising:
controlling one or more robotic systems using the schedule.

14. The method of claim 12 further comprising:
monitoring one or more robotic systems using the schedule.

15. The method of claim 12, wherein the graph network has a stochastic policy model that jointly learns to pick agents and tasks without interacting with an environment between intermediate scheduling decisions and only needs a single reward at an end of schedule.

16. The method of claim 12, wherein the recurrent decoder comprises an agent selector and a task selector, wherein the agent selector is configured to select a new agent for a next decision based on state and agent information, and wherein the task selector is configured to assign tasks for a selected agent based on the state, agent, and unscheduled task embeddings.

17. The method of claim 15, wherein the stochastic policy model has a step-based baseline.

18. The system of claim 15, wherein the stochastic policy model has a greedy rollout baseline.

19. A non-transitory computer-readable medium having instructions stored thereon, wherein execution of the instruction by a processor causes the processor to:
execute a graph network configured to encode information associated with resources and tasks; and
execute a recurrent decoder configured to receive an output of the graph network to determine a schedule while accounting for one or more spatiotemporal constraints established by the graph network, wherein the recurrent decoder is configured to generate consequential models of each task-agent assignments based on an initial model, and
wherein the schedule is employed to control or monitor one or more robotic systems.

20. The non-transitory computer-readable medium of claim 19, wherein the recurrent decoder comprises an agent selector and a task selector, wherein the agent selector is configured to select a new agent for a next decision based on state and agent information, and wherein the task selector is configured to assign tasks for a selected agent based on the state, agent, and unscheduled task embeddings.
